(19) United States
(12) Patent Application Publication
(10) Pub. No.: US 2002/0198935 A1
(43) Pub. Date: Dec. 26, 2002

(54) Methods and systems for validating the fields of a form

(76) Inventors: Steven Allen Crandall SR., Wilmington, OH (US); Steve Farshid Naghshineh, Cincinnati, OH (US); Kelly Wayne Grandstaff, Wilmington, OH (US)

Correspondence Address: DINSMORE & SHOHL, LLP, 1900 CHEMED CENTER, 255 EAST FIFTH STREET, CINCINNATI, OH, 45202, US

(21) Appl. No.: 09/888,855

(22) Filed: Jun. 25, 2001

(51) Int. Cl. G06F 15/16

(52) U.S. Cl. 709/203; 707/507

(57) ABSTRACT

Methods for validating fields of a form are provided. In a client-server transaction, wherein a form is received by the server having one or more fields associated therewith. Input data are received from the client and associated with the fields of the form, once the input data are received on the server, or within the fields of the form, it is validated.

Moreover, a method of processing a form during a client-server transaction is provided wherein a client-server connection is established between a client and a server. Next, input data from the client are received and associated with a first field of a form. The input data are validated before permitting the client to provide additional data associated with a second field of the form.

Further, a method of processing a shipping form is provided wherein a shipping form is received on a server. The form has one or more modifiable fields. Input data inserted by the client into one or more the fields are interactively validated as provided by the client.

### FIELD OF THE INVENTION

The present invention relates to methods of validating fields of a form in a client-server transaction.

### BACKGROUND OF THE INVENTION

Accessing and filing out forms in electronic format has become omnipresent in recent years, especially with the advent of the Internet and the pervasive access being supplied through the use of Browsers, such as MICROSOFT'S INTERNET EXPLORER and NETSCAPE. The forms are supplied as electronic files written in specific data markup languages such as, and by way of example only, hypertext markup language (“HTML”), extensible markup language (“XML”), and the like.

Specific identified areas within the form often require entry by an end user, these areas are referred to as fields and are typically identified by special markup tags contained within the form, which allow the end user to visually inspect on a computing device's monitor specific areas where data needs to be supplied by the end user. These fields will also include labels which are associated with the input areas and permit the end user to determine what type of input data is required within any particular field.

Typically, once all fields of the form have been filled in, an electronic button usually identified with a label of “submit” or “send” is activated by the end user depressing the button, and all the data supplied in the fields of the form are transmitted to a server computing device, or remote computing device, for processing. Once received, each field of the form having input data is validated against a set of syntactic or semantic rules associated with the form to ensure the proper data has been supplied within the form.

By way of example only, some fields may be required to have data, such as a field identified with the label “email.” Moreover, some fields may not accept alphabetic characters, such as fields identified with the label “phone number.” As is apparent to those skilled in the art, the variations of possible semantic and syntactical validations would depend on the information which the fields of the form were attempting to process.

Once the data are received by the validating process on the server computing device, if errors are detected the data are resent to the client computing device of the end-user and the end-user, is informed with an electronic message that the data provided for a particular field of the form was incorrect and needs to be resupplied.

Further, if the end-user does not have his/her browser set up properly to provide caching, the user may have all previous but correctly inputted field data missing when the end user receives notification that a particular field had some invalid data. This is particularly inefficient and inconvenient for the end user, since often the input data provided to the form may be quite voluminous and entering it all into the form is quite time consuming for the end user.

Moreover, some form processing applications will stop processing a form altogether once invalid data for a field is detected and will return an error message to the end user. This becomes a problem because, the input data provided by the end user may be associated with many different fields and since the form processing stops executing after detecting a single error in a single field, the end user is forced to continually submit the form completely filled out to the processing application and correct any detected errors one by one, repetitively.

To alleviate this problem, form processing applications have permitted end users to download software to their computing devices. In this way the fields of the form, may be interactively validated by software residing on the end user's computing device. However, this is inefficient, since should the form itself or fields of the form be modified, then the end user will be required to obtain an updated copy of the software in order to take advantage of this interactive validation of the form.

Often during an Internet transaction occurring over the Internet through a browser, the ability to provide the end user software to achieve some result, such as validation of data provided to a form, is referred to as client-side scripting. End users often are concerned that downloaded software to their client computing device may contain computer viruses, and are therefore reluctant to acquire the software. Further, the provider of the software must be continually rendering advice and updates to the end users about updated versions of the software or additional software as it becomes needed by the end user.

Furthermore, often a single software application will be developed for a single form, which proliferates the number of available software applications as the number of forms and types of forms grow for the end user. Because of these inherent drawbacks to client-side scripting in a client-server transaction, businesses have not readily embraced the concept, and users are forced to completely fill all the fields of a form and then submit the form all at once for the form processing which resides on the server.

Additionally, software may be distributed to an end user through traditional channels such as CD ROM or other computer readable media, and the software itself may include the logical instructions to validate the fields of a form prior to sending the completed form electronically to a form processing application. This approach is even more problematic than providing client-side scripts, which are downloaded from an Internet site, since distribution of updated versions of the software or additions to the forms becomes burdensome and expensive to maintain for the software provider.

Accordingly, more efficient methods of validating the fields of a form during a client-server transaction need to occur, such that the end-user need not concern himself/herself with security issues, and the vendor of the form processing application need not concern itself with maintaining and providing multiple variant versions of the software, where each version of the software may quickly become dated and expensive to track and support.

### SUMMARY OF THE INVENTION

Accordingly, an object of the invention is to provide methods for validating fields of a form where validation occurs interactively on the server side of a client-server transaction. A client initially establishes a connection with a server, the connection may be made via the Internet (or any other remote connection) or via a direct connection between the client and the server. Once a connection is established, the client is presented with an electronic form having one or more input fields requiring input data from the client.

As the client inputs data into the fields, the server validates that the data inputted conform to appropriate syntactical or semantic rules associated with each individual field of the form. If a syntactical or semantic error is detected in the input data provided by the client, then executable instructions, residing on the server, interactively notifies the client and may suggest to the client an appropriate response to correct the error in the data. As one skilled in the art will readily appreciate, this increases the efficiency and performance associated with processing a form during a typical client-server transaction.

Additional objectives, advantages and novel features of the invention will be set forth in the description that follows and, in part, will become apparent to those skilled in the art upon examining or practicing the invention. The objects and advantages of the invention may be realized and obtained by means of the instrumentalities and combinations particularly pointed out in the appended claims. To achieve the foregoing and other objects and in accordance with the purpose of the present invention, methods for interactively validating the fields of a form are provided.

One aspect of the present invention provides a method of validating fields of a form in a client-server transaction, having executable instructions, where a form having one or more fields is received on a server. Further, the client provides input data which are associated with the fields, and the input data are validated on the server once received or as received within the fields of the form.

In another aspect of the present invention a method of processing a form during a client server transaction is provided, having executable instructions where a client-server transaction is established between a client and a server and input data are received from the client and associated with a first field of a form. The client is not permitted to provide additional data for a second field of the form until the input data are validated.

In still another aspect of the present invention a method of processing a shipping form is provided, having executable instructions where a shipping form on the server is received having one or more modifiable fields and input data inserted by the client into one or more of the fields are interactively validated on the server as provided by the client.

Still other aspects of the present invention will become apparent to those skilled in the art from the following description of an exemplary embodiment, which is by way of illustration, one of the exemplary modes contemplated for carrying out the invention. As will be realized, the invention is capable of other different and obvious aspects, all without departing from the invention. Accordingly, the drawings and descriptions are illustrative in nature and not restrictive.

### BRIEF DESCRIPTION OF THE DRAWINGS

The accompanying drawings, incorporated in and forming part of the specification, illustrate several aspects of the present invention and, together with their descriptions, serve to explain the principles of the invention. In the drawings:

FIG. 1 depicts a flow diagram of a method of validating fields of a form;

FIG. 2 depicts a flow diagram of a method of processing a form; and

FIG. 3 depicts a flow diagram of processing a shipping form.

### DETAILED DESCRIPTION

The present invention provides methods for interactively validating the fields of a form. An exemplary environment includes an Internet connection between a client computing device and a server computing device, the client interface is achieved using a browser, such as by way of example only MICROSOFT'S INTERNET EXPLORER, the forms provided are marked up in HTML or XML and then rendered using Extensible Stylesheets (“XSL”). Input fields of the form are validated using the scripting programming language called Active Server Pages (“ASP”).

Of course other connections, client interfaces, data mark-up languages and programming languages (now known or hereafter developed) may also readily employed. Moreover, as will be apparent to one skilled in the art the present invention may be used in combination with existing technologies, such as secured sockets layer (“SSL”) technologies, and others.

Initially, an electronic form is constructed, this form may be tagged utilizing a number of existing or hereafter developed mark-up languages, such as and by way of example only HTML, XML, XSL, and the like. Within the form are distinct data areas where input data may be permissibly received, these areas are often referred to as fields within the form, although this language is used for convenience, in fact any area which receives some type of response from an end user may actually be considered a field within the form. For example, radio buttons require an end user to select a single choice among a variety of choices presented by clicking a graphical box or a graphical circle displayed on the end user's display screen. Further, pull down menu selections require the end user to select from a pull down option a variety of predetermined selections. In this way, and others that would be readily apparent to those skilled in the art, fields of a form may be more than just plain input areas within a form where textual data is entered by the end user.

Moreover, although a variety of ways to obtain input data from a field of a form exist and would be readily apparent to those skilled in the art, the following is one example of an HTML encoded portion of an electronic form where an end user would be prompted to input data associated with his/her name and where the inputted data is associated with a variable tag name used by a set of executable instructions to further validate that the data provided by the end user conform to syntactic rules, such as rules requiring only alphabetic characters to be entered into the variable tag name. For example, consider the following text string contained within a form representing a field within the form and a text label associated with the field:

<td align=center> Name: <input TYPE=“TEXT” NAME=“USERDATA”>

Where the HTML tag string “<td align=center>” indicates that a label tag follows which is to be centered, that label tag is “Name:” and will be displayed to the end user as a label for an input field which follows the label. This input field is defined by the HTML tagging “<input TYPE=“TEXT” NAME=“NAME”>.” The first string within the characters “<” and “>” is the command string “input” which indicates that the area to be displayed is to actually receive data from an end user. Depending on the browser used by the end user, this will cause an area of the end user's display screen to permit the inputting of data provided by the end user.

Next, the string “TYPE=‘Text’” identifies the type of data which the end user may input, in this case that type of data is textual data. The next string encountered: “NAME=‘NAME’” indicates that the variable tag name associated with the data input by the user will be referenced by any subsequent executable instructions by the string “NAME” which appears on the left-hand side of the equal sign, the use of the string “USERDATA” on the right-hand side of the equal string is the actual value of the input data provided by the end user and that value is assigned to the variable name “NAME” which appears to the left-hand side of the equal string.

As will be apparent to those skilled in the art, a variety of data markup may be used to accomplish the effect of a field within a form, and the example presented above is for illustrative purposes only. Moreover, although the input type is identified as text, this does not necessarily mean that the data provided by the user will be validated as the user enters data into the name field.

Further, it is more likely that no validation will occur at all until all data within the form is entered and the form is submitted to a server computing device for purposes of validating the form. Having a type of data, simply allows validation to be somewhat simplified by restricting certain types of operations on that data, once an application of executable instructions using the inputted data attempts to process the data. For example, typical arithmetic operations such as divide should not be permissible operations on data identified as type text, rather, these operations are more appropriate on data identified as type integer.

Furthermore, although discussions have been presented with respect to clients and servers, as one skilled in the art will readily appreciate, a client may be a server and a server may be a client. In other words, any computing device capable of processing executable instructions may be a client and a server. The status of whether any particular computing device is in fact a server or a client at any particular point time is best exemplified by what it is attempting to do at any point in time. So, if a request is made from an external computing device to perform some operation to a receiving computing device, the receiving computing device may be acting as a server since it is remotely servicing a request from an external computing device.

Conversely, if the same computing device originally acting as a server in the above example, permits an end user to log onto it directly and perform operations on it directly, then it is acting as a client, or if the computing device sends a remote request to another external computing device to perform some operation, it may be termed a client computing device for that particular transaction.

Moreover, client-server transactions occur after some form of connection is made between the client and the server. Connections may occur in a variety of ways, such as by way of example only, peer-to-peer, direct dial-up, Internet, and others. The connections may be hardwired in the case of local area networks (LANs) and wide area networks (WANs), or they may be wireless using radio waves, infrared, satellite, and other technologies.

More typically, in recent years end users make connections between computing devices without realizing how this is actually occurring via the Internet, and the end user interface is typically provided using a browser, and the data markup language being displayed and interacting within the browser is usually written in HTML, XML, or XSL. Although, it is readily apparent to those skilled in the art that any number of connections, user interfaces, and data markups may be used without departing from the invention herein provided.

Consider by way of example only, shipping forms such as bills of lading which are customary in the shipping industry. These forms may have a variety of fields included therein such as the consignee's name, consignee's address, shipper's name, shipper's address, billing information, quote numbers, order numbers, account numbers, package description, number of packages, package type, package class, carrier information, and the like.

These forms may be lengthy and time consuming to do by hand, or to do repetitively when only minimal changes are required thereto. Appropriately automating the processing of these forms provides tremendous advantages within the shipping industry, by reducing time and expense associated with filling in the fields of the forms, validating the fields of the forms, tracking histories and status related to the forms, and providing reports related to the forms, and the like.

Accordingly, in one embodiment of the present invention these forms are provided via the Internet from a serving computing device and encoded in HTML or XML which may then be rendered to HTML when accessed using XSL. The user establishes a client-server transaction by clicking on a web address typically referred to as a uniform resource locator (URL), once activated the URL locates the appropriate Internet Protocol (IP) address of a serving computer device and provides the data mark-up located at that IP address, this data may be directly provided or rendered depending upon the sophistication of any applications residing on the IP address, and the application's ability to customize based on end user attributes.

Continuing with the present example, a customer desiring a bill of lading accesses the IP address using a browser and receives a form encoded or rendered into HTML, where the fields of the bill of lading are clearly delineated as presented above. However, rather than permitting the form to actually be sent to the end-user's computing device (e.g. client), the end user interacts with the form and fills out the fields of the form on the IP address (e.g. server) where the bill of lading form resides. In this way as the end user enters data into the various fields of the form, the fields may be validated for accuracy, both syntactically and semantically by the applications residing on the server.

In this way, errors detected in the input data provided by an end-user from a client computing device may be immediately detected and the end user notified immediately. This validation may occur before the all fields of the form are completed, or it may occur before a single field of the form is completed. For example, if syntactically only alphabetic characters are permitted within the consignee name field, then should an end user attempt to enter a numeric character, a beep may be made or a message may be displayed to the end-user indicating that numeric characters are not permitted. Alternatively, as the user attempts to jump from field to field within the form by using his computing device's mouse or by using the keyboard's arrow/tab keys a single field from which the end user is exiting may be validated for accuracy, and the end user will not be permitted to continue with processing the fields of the form until the error is rectified.

As one skilled in the art will readily appreciate, the ability to process electronic forms on the server side of the transaction as the fields of the form are filled in by an end user from a client computing device provides tremendous performance and usability benefits to the end user, and the service provider of the form.

For example, the end user does not have to worry about waiting until a multiple page form is completely filled in to learn of a typographical error, nor does the end user have to worry about downloading client-side scripting utilities on to the end user's computing device which may quickly become outdated or potentially contain computer viruses.

Moreover, from the perspective of the form service provider, multiple forms may be supported from a single location and the distribution of validation executable instructions is straightforward, so support and maintenance and ease of use are greatly improved.

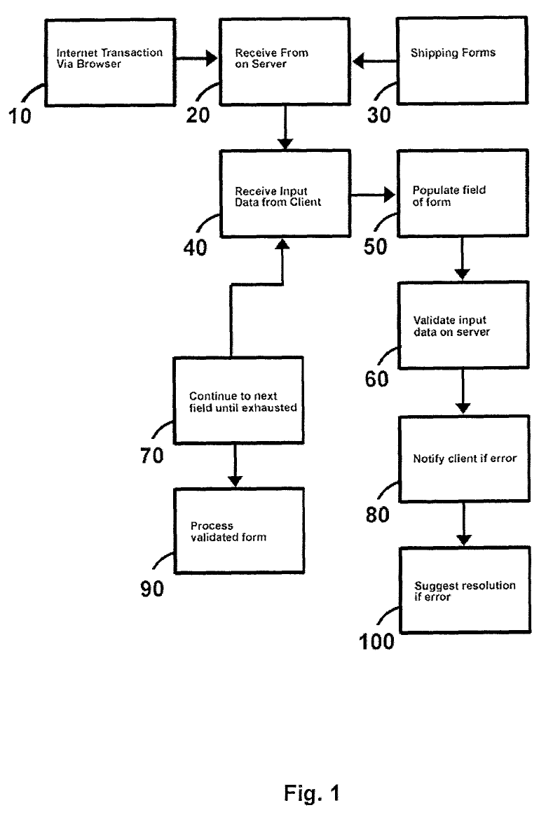

FIG. 1 depicts a flow diagram of a method of validating fields of a form. Initially, an Internet transaction occurs via a browser in step 10 and a connection, either directly or indirectly, is established with a server computing device. The server computing device receives a form in step 20, the form may be encoded in any number of data markup languages, as presented and discussed above. More particularly in step 30, the forms may, by way of example only, be related to the shipping industry such as bill of lading forms, pickup requests, status, tracking, credit applications, rate quotes, document retrieval, history, and the like.

Once the form is presented or rendered to the end user via the end user's computing device and through the end-user's browser (although any customized user interface may also be used, in which case proprietary data markup may be used as opposed to markup associated with open standards, such as HTML and XML), the end-user begins to populate the fields of the form. As this is done, the data are received in step 40 by the server computing device, and the fields are populated in step 50.

As the data provided by the end user are entered into any particular field of the form, it is validated in step 60 on the server computing device. As previously presented, this validation may occur as the user enters data within a single field or as the user attempts to exit a field upon completely entering data for the exited field. If the data inputted within any particular field are not correct, the end user is notified electronically in step 80.

This may be done by redisplaying a new form with additional notice information to the end-user, or rather, by displaying a separate window to the end user which pops up and notifies the end user of the error. Although as one skilled in the art will readily appreciate a variety of notification mechanisms may be used all without departing from the present invention.

Notifications of error conditions contained within the inputted data may also include suggestions for resolving the error conditions in step 100. For example, if the end user enters a numeric character “9” in the consignee name field, a notification may be sent to the end user via a pop-up window telling the user that the use of numeric characters within the consignee name field is not permitted and only alphabetic characters should be entered. Although the present example presents an error condition wherein a consignee name includes a numeric character, it should be recognized that in the shipping industry this may not be an error condition and is presented herein only for purposes of illustration.

Each field requiring input from the end user proceeds through steps 50, 60, 80, and 100 until all fields within the form have been validated in step 70. At this time, the form includes all the appropriate data and may be processed in step 90. Processing may include any additional applications which require the data of the form, such as scheduling or recording a bill of lading, or optimizing a pickup and delivery route for the carrier, and others.

Moreover, although examples are being presented herein with respected to the shipping industry it should be readily apparent that the present invention may be practiced with any server based form processing applications in any industry where client-server transactions are occurring.

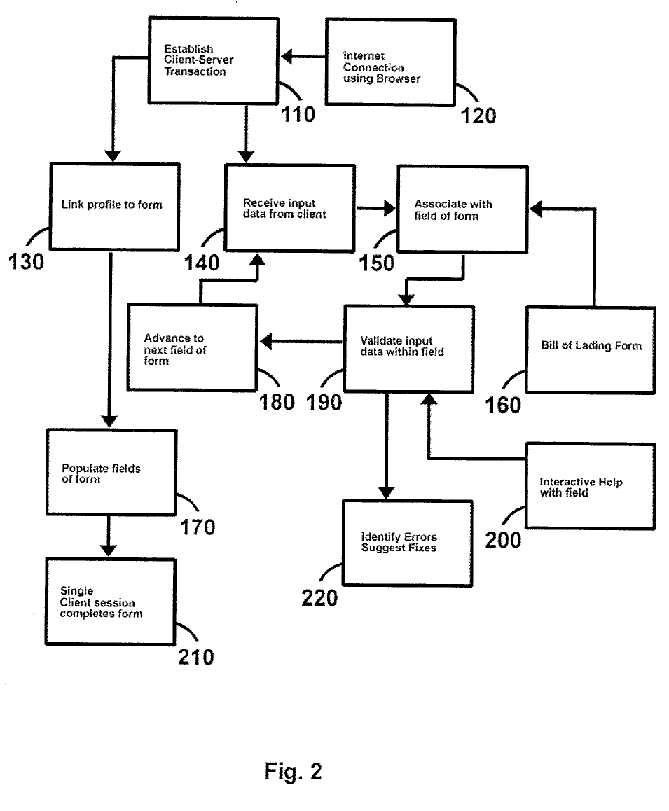

FIG. 2 depicts a flow diagram of a method of processing a form. A client-server transaction is established in step 110, and although not required, the connection may occur over the Internet using a client computing device having a browser application executing thereon as depicted in step 120. A form having one or more fields are received and displayed through the browser, or other end user interface (e.g. customized window applications) to the end user interacting via the client computing device.

Moreover, an electronic profile may be associated with an end user, the profile may include data which assist in automatically populating the fields of any form presented to the end user. A specific end user's profile may be selected and retrieved by requiring a user identification, and account identification, user phone number, and the like. Further, if desired a validation may occur by requiring a password associated with the user. The retrieved user profile may include data which is useful in populating the fields of a form, and the user may link the profile to one or more specific forms in step 130.

Data provided by the end user is received on the server computing device in step 140 and this data may include data automatically populated to one or more fields of the form using any profile associated with the end user and/or form in step 150. Data inputted into the fields are validated in step 190 and any errors associated therewith along with suggested corrections made in step 220. As previously presented one or more of the forms may be associated with shipping, such as bill of lading forms in step 160. Moreover, each field may have interactive help associated with it in step 200.

Interactive help may permit the user to use a specific button contained within the form or use a special keyboard key such as a function key while within a specific field of the form to trigger an event within the server application processing the form, which then present, to the user, on-line interactive help associated with the requested field of the form.

As each field of the form is validated within the form, the end user advances to the next field of the form in step 180 until the entire form is completed. As one skilled in the art will appreciate the form need not have all fields populated to be complete, it may in fact be determined to be complete once all the required fields included within the form have been properly entered, even though one or more non required fields within the form are not populated with any end user provided data.

Alternatively, an entire form and all the relevant fields of the form may be populated by using a single selection button, once a form has been linked to a profile as depicted in step 170. A single end user selection causes the entire form to be populated and processed as depicted in step 210. This would be particularly useful in the shipping industry where a repetitive bill of lading is created by a particular end user. The ability to create a profile associated with the end user and the information included within the bill of lading would be of tremendous benefit to the end user. And, having the ability to generate the bill of lading with a single click would greatly improve usability and efficiency in the shipping industry. Although as one skilled in the art will readily appreciate, any industry would benefit from the same method depicted herein.

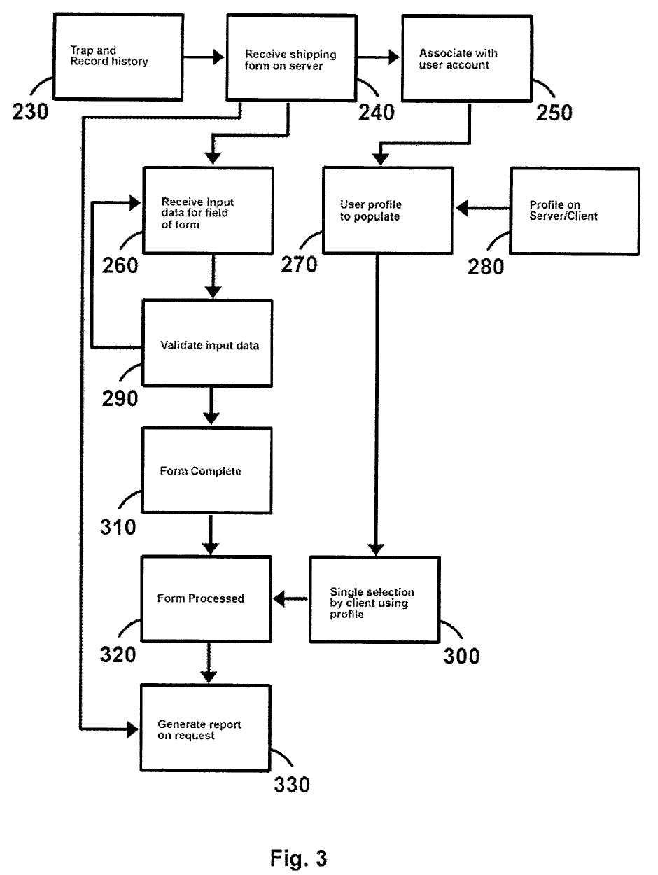

FIG. 3 depicts a flow diagram of processing a shipping form. A shipping form, such as by way of example only a bill of lading, is received for processing on a server computing device having one or more fields requiring input data to be provided from an end user. As one skilled in the art will appreciate, an end user need not be a physical person, but may rather be another software application which automates the behavior of user, an account, and the like.

In step 250, the end user is associated with an account, by using any unique information which would permit a software application to uniquely identify a specific user/account. Once a connection between a client computing device, through which the user is interacting is made, with the server computing device is made, and the appropriate user account is identified, a set of executable instructions may execute in the background during the form processing to record a history associated with the user interactions with the server. This history may trap a variety of information, such as and by way of example only, date, time, form requested, form processed, and the like.

Once a specific form is selected by the end user, the fields of the form may be populated entirely by using a profile of the user in step 280 and 290 and upon a user selection made in step 300. The profile associated with the user may reside on the server or may reside on the client computing device. Although, processing of the fields of the form are performed on the server, some users may be extremely sensitive to recordation of profiles being housed on a remote computing device (e.g. server) as a result, an option would permit the user to store profile information locally on his/her computing device, or permit the server to warehouse the profiles.

In either case retrieval and use of the profile data are straightforward and easily obtained by anyone skilled in the art, as long as the data file or data store having the profile maintains a consistent naming convention and consistent internal data structure. If the entire form is populated by using a single selection which incorporates the user's profile, and the form is processed in step 320.

Alternatively, the fields of the form may be partially populated by the using the user's profile (not depicted in FIG. 3), or the user may provide all the necessary input data for each of the required fields of the form manually. In this latter case, the input data for each field is received by the server as it is entered by the user on the server in step 260, whereupon it is validated in step 290 for syntactical or semantical correctness Again, should errors be detected the user may be interactively notified of the same along with suggested fixes to remedy the errors (not depicted in FIG. 3).

Once all required fields of the form have been validated and entered interactively by the user, the form is identified as being complete in step 310 and processed in step 320. Moreover, user reports may be generated detailing activity associated with the shipping forms, since as previously presented a history associated with each user interaction with the server is being trapped and recorded.

The foregoing description of an exemplary embodiment of the invention has been presented for purposes of illustration and description. It is not intended to be exhaustive nor to limit the invention to the precise form disclosed. Many alternatives, modifications, and variations will be apparent to those skilled in the art in light of the above teaching. Accordingly, this invention is intended to embrace all alternatives, modifications, and variations that fall within the spirit and broad scope of the attached claims.

What is claimed:

1. A method of validating fields of a form in a client-server transaction, having executable instructions, comprising:
receiving a form having one or more fields on a server;
receiving from a client input data associated with one or more of the fields of the form; and
validating the input data on the server once received or as received within one of the fields of the form.

2. The method of claim 1, further comprising:
notifying the client as soon as an error is detected, if detected at all, within one of the fields of the form.

3. The method of claim 2, further comprising:
identifying a specific resolution if an error is detected and communicating the resolution immediately to the client.

4. The method of claim 1, further comprising:
processing the form after each field has been properly completed by the client.

5. The method of claim 4, wherein the form is associated with a shipping request.

6. The method of claim 1 wherein communication between the client and the server occurs over the Internet.

7. The method of claim 6, wherein the form is displayed within a browser.

8. A method of processing a form during a client-server transaction, having executable instructions, comprising:
establishing a client-server transaction between a client and a server;
receiving input data from the client associated with a first field of a form; and
validating the input data before permitting the client to provide additional data associated with a second field of the form.

9. The method of claim 8, further comprising:
interactively notifying the client of an error if the input data are not validated.

10. The method of claim 9, further comprising:
suggesting a correction to the client to remedy the error if present.

11. The method of claim 8, wherein the client-server transaction occurs over the Internet using a browser interface.

12. The method of claim 8, wherein the form is associated with a bill of lading.

13. The method of claim 8, further comprising:
providing interactive help for the fields upon a request of the client.

14. The method of claim 8, further comprising:
linking a profile to the first and second fields of the form.

15. The method of claim 14, further comprising:
automatically populating the first and second fields of the form based on the profile.

16. The method of claim 15, further comprising:
completing the form and a client request with a single client selection identifying the profile.

17. A method of processing a shipping form having executable instructions, comprising:
receiving a shipping form on a sever identified by a client having one or more modifiable fields; and
interactively validating on the server any input data inserted by the client into one or more of the fields as the input data are provided by the client.

18. The method of claim 17, further comprising:
associating a user's account with the shipping form.

19. The method of claim 18, further comprising:
establishing a user's history associated with completing the shipping form.

20. The method of claim 19, further comprising:
creating a customized report associated with the user's account or the user's history.

21. The method of claim 17, further comprising:
bypassing the validating step and automatically providing valid input data to populate the fields based on a user's profile associated with the shipping form.

22. The method of claim 21, wherein the user's profile is maintained on the server.

23. The method of claim 21, wherein the user's profile is maintained on the client.

24. The method of claim 21, wherein a single selection by the client initiates the bypass step and submits a completed shipping form for processing.
